(19) United States
(12) Patent Application Publication
(10) Pub. No.: US 2026/0063929 A1
(43) Pub. Date: Mar. 5, 2026

(54) INTEGRATED ELECTONICS AND PHOTONICS SYSTEMS

(71) Applicant: Quantinuum LLC, Broomfield, CO (US)

(72) Inventors: David A. Deen, Edina, MN (US); Christopher T. Ertsgaard, Champlin, MN (US); Alexander M. Zolot, Broomfield, CO (US)

(21) Appl. No.: 19/310,458

(22) Filed: Aug. 26, 2025

Related U.S. Application Data
(60) Provisional application No. 63/687,552, filed on Aug. 27, 2024.

(51) Int. Cl. G02F 1/01

(52) U.S. Cl. CPC G02F 1/0121

(57) ABSTRACT

A confinement apparatus system comprises a photonic layer. The photonic layer comprises optical elements. At least one of the optical elements is configured to output an optical signal. The confinement apparatus system further comprises a monitoring-control layer. The monitoring-control layer comprises at least one of monitoring circuitry or feedback control circuitry.

### CROSS-REFERENCE TO RELATED APPLICATIONS

This application claims priority to U.S. Provisional Patent Application No. 63/687,552, filed on Aug. 27, 2024, which is incorporated herein by reference in its entirety.

### TECHNICAL FIELD

Various embodiments relate to apparatuses, systems, and methods relating to co-integrated electronics and photonics systems. An example embodiment relates to a confinement apparatus system with co-integrated photonics and electronic feedback and control circuits.

### BACKGROUND

Various embodiments of the present disclosure address technical challenges related to confinement apparatus systems. Through applied effort, ingenuity, and innovation, Applicant has solved problems related to electronic feedback and control in confinement apparatus systems with integrated photonic components by developing solutions embodied in the present disclosure, many examples of which are described in detail herein.

### BRIEF SUMMARY OF EXAMPLE EMBODIMENTS

In accordance with one aspect of the present disclosure, a confinement apparatus system is provided. In some embodiments, the confinement apparatus system comprises a photonic layer comprising a plurality of optical elements, wherein at least one optical element of the plurality of optical elements is configured to output an optical signal; and a monitoring-control layer comprising at least one of (i) monitoring circuitry or (ii) feedback control circuitry.

In some example embodiments, the confinement apparatus system further comprises an isolation layer formed on the monitoring-control layer, wherein the photonic layer is formed on the isolation layer.

In some example embodiments, the plurality of optical elements comprises one or more of (i) one or more opto-electronic sensors, (ii) one or more light sources, (iii) one or more passive photonic components, or (iv) one or more active photonic components.

In some example embodiments, the monitoring-control layer is configured for monitoring and controlling one or more optical parameters of the optical signal, wherein the one or more optical parameters include at least one of (i) amplitude, (ii) polarization, (iii) phase, (iv) alignment or (v) optical power.

In some example embodiments, the monitoring circuitry comprises at least one of (i) one or more detection circuitries or (ii) a multiplexer array.

In some example embodiments, each detection circuitry of the one or more detection circuitries comprises a detector and one or more of a (i) biasing component, (ii) an amplifier, and (iii) a quench and filter network, wherein the detector is configured to receive an optical signal from one or more of (i) the at least one optical element or (ii) a qubit quantum object, and wherein the multiplexer array is configured to output a conditioned signal corresponding to the received optical signal.

In some example embodiments, the monitoring circuitry comprises a PID controller configured to monitor optical signals corresponding to output of the at least one optical element or a qubit quantum object; analyze the optical signals by comparing the optical signals to a setpoint; and adjust one or more optical modulators based on the analysis of the optical signals.

In some example embodiments, the confinement apparatus system further comprises one or more electrodes and an optical encoding circuitry configured for monitoring electrical drive signals delivered to the one or more electrodes.

In some example embodiments, the optical encoding circuitry comprises an optical modulator configured to encode one or more signal characteristics of the electrical drive signals onto an optical carrier; and a detector configured to read the encoded one or more signal characteristics.

In some example embodiments, the monitoring-control layer further comprises the optical encoding circuitry.

In some example embodiments, the monitoring-control layer further comprises an integrated digital servo configured for providing optical signal feedback and control.

In some example embodiments, the plurality of optical elements of the photonic layer comprise one or more optical modulators, and the feedback control circuitry is configured to control the one or more optical modulators.

In some example embodiments, the one or more optical modulators comprise an acousto-optic modulator or an electro-optic modulator.

In some example embodiments, the confinement apparatus system further comprises a confinement apparatus chip, wherein at least one of the photonic layer or the monitoring-control layer is formed on the confinement apparatus chip.

In some example embodiments, the confinement apparatus chip comprises an optically transparent substrate.

In some example embodiments, the confinement apparatus system further comprises an ancillary chip, wherein at least one of the photonic layer or the monitoring-control layer is formed on the ancillary chip.

In some example embodiments, the ancillary chip comprises an optically transparent substrate.

In some example embodiments, the ancillary chip is one of a bridge chip, a cloud chip, or an external chip.

In some example embodiments, the confinement apparatus system further comprises a confinement apparatus chip and an ancillary chip, wherein the photonic layer is formed on the confinement apparatus chip and the monitoring-control layer is formed on the ancillary chip

In some examples, the confinement apparatus system further comprises a confinement apparatus chip and an ancillary chip, wherein the photonic layer is formed on the ancillary chip and the monitoring-control layer is formed on the confinement apparatus chip.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic diagram illustrating an example quantum computing system comprising an example confinement apparatus with integrated electronics and photonic components, according to an example embodiment.

FIG. 2 is a schematic top view of a portion of an example confinement apparatus with integrated electronics and photonic components, according to an example embodiment.

FIG. 3A provides a schematic cross-section view of portions of an example confinement apparatus system, according to an example embodiment.

FIG. 3B provides a schematic cross-section view of a confinement apparatus system showing an example schematic of a monitoring circuitry and an example schematic of a feedback control circuitry thereof, according to an example embodiment.

FIG. 3C provides an example schematic diagram of an example optical encoding circuitry, according to an example embodiment.

FIG. 4 provides a schematic diagram of an example controller of a quantum computer, according to an example embodiment.

FIG. 5 provides a schematic diagram of an example computing entity of a quantum computing system that may be used, according to an example embodiment.

FIG. 6 provides a visualization of an operational example of a portion of a confinement apparatus system, according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

### Overview

Example embodiments provide apparatuses, systems, and corresponding methods relating to co-integrated photonics and electronics feedback and control systems. An example embodiment relates to a confinement apparatus system with co-integrated photonics and electronic feedback and control circuits. For example, the confinement apparatus system includes or otherwise leverages optical elements (e.g., opto-electronic sensors, light sources (e.g., lasers, LEDs, or the like), passive photonic components, active photonic components, and/or the like) and/or electronic elements that are co-integrated and configured to perform one or more functionalities of the confinement apparatus system.

Various embodiments provide technical solutions for monitoring and controlling optical performance of one or more optical elements of photonic integrated confinement apparatus. An implicit requirement for photonic integrated circuits (PIC) is the control infrastructure for system-level operation. Active integrated photonic components such as modulators, photodetectors, and solid-state sources like a laser diode must be networked with various electronic and optoelectronic circuitry for control of the photonic system. Even passive integrated photonic components require optical pick-offs for monitoring photonic beamline integrity and thereby utilizing optoelectronics for passive monitoring. Accordingly, a need exists for a fully-integrated photonic platform with the photonic components, optoelectronics, and control electronics monolithically co-integrated into a single chip.

Various embodiments of the present disclosure provide such integration and provide technical solutions to technical problems associated with integrating photonic components, optoelectronics, and control electronics monolithically into a single chip. In particular, various embodiments of the present disclosure include integrated circuit (IC) layers comprising a photonic layer and a monitoring-control layer formed and/or disposed on a substate such as silicon (Si) substrate or other substrate. In an example embodiment, the monitoring-control layer includes a Si Complementary Metal-Oxide-Semiconductor (CMOS) control circuitry integrated on a silicon wafer followed by an electrical and optical isolation layer with the integrated photonics layer terminating the layer structure with electronic and photonic interconnections made from layer to layer by vias, directional coupler, and/or grating couplers.

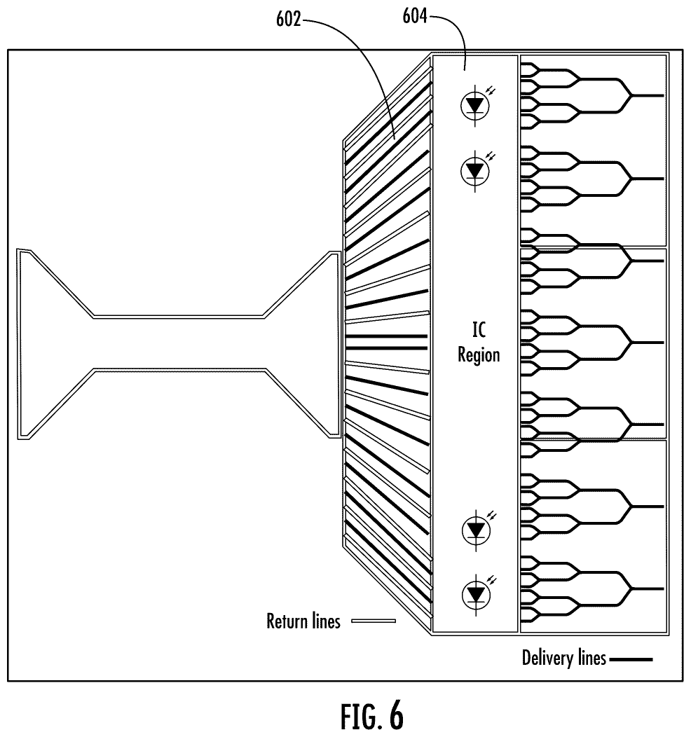

In some embodiments, optical loop-backs consisting of waveguides and input couplers and/or directionally coupled pickoffs running parallel to waveguide lines are configured to red-direct optical signals to designated IC regions (such as IC region 604 shown in FIG. 6) for power monitoring (e.g., via a photodiode). In some embodiments, the waveguide lines are combined with other passive operations (e.g., polarization filters, ring-resonators, interferometers, spatial filters, and/or the like) for direct monitoring of polarization, phase, frequency stability, and/or spatial intensity distribution. In some embodiments, vertically stacked directional couplers and/or grating couplers are leveraged to direct light vertically within the ion trap stack to specific IC layers. In some embodiments, in addition to monitoring performance, the IC may be configured to provide feedback control to modify amplitude, polarization, phase, optical power, or alignment correction in-situ. For example, this may be configured and/or embodied as a modulation of the permittivity and/or physical dimensions (e.g., piezoelectrics) of an optically addressed layer. In this regard, the CMOS processes may be effectively decoupled from the photonics processes while simultaneously leveraging monolithic integration. In some embodiments, an electrical interconnect and feedthrough scheme may be built into the ion trap stack and may include a peripheral edge with bond pads for electrical connections to a package (e.g., an ion trap chip having an ion trap defined thereon). In some embodiments, this may be integrated monolithically within the ion trap, exist as an optical chiplet parallel to the ion trap, and/or exist vertically stacked as a flip-chip or cloud PIC configuration.

Various embodiments include silicon-based diode, such as an avalanche photodiode (APD), that is leveraged to integrate the photonic layer and the monitoring-control layer. In various embodiments, the photonic layer includes one or more components configured for direct monitoring of one or more optical parameters. Further, in various embodiments, the photonic layer includes one or more components configured to re-direct optical signal to the monitoring-control layer for monitoring and/or control of optical performance.

In this regard, example embodiments of the present disclosure provide various technical advantages at least by providing such integration described herein. For example, example embodiments of the present disclosure minimize the footprint of the optical beam delivery system. Example embodiments of the present disclosure minimize optical and electronic loss due to idealized system interfacing at the micro- or mesoscopic scale. Example embodiments of the present disclosure minimize latency between system output and control processes. Example embodiments of the present disclosure minimize vibration given that the photonic components and electronics are maximally registered to each other. Example embodiments of the present disclosure reduce noise injection due to cryogenic operation of both detector and supporting electronics. Example embodiments of the present disclosure provide for on-chip switching capability that can extend the ion trap package lifetime where degraded beamlines (e.g., waveguides and input facets) could be routed around without the need for full trap and beamline replacement. Moreover, with the large signal count of a full scale Quantum Charge Coupled Device (QCCD), patterning redundant lines on chip according to techniques described herein significantly reduces manufacturing and maintenance costs.

In some embodiments, the integration scheme for control and signal processing electronics with active photonic elements include both monolithic homogeneous and heterogenous integration. The monolithic integration may include silicon-based detectors (e.g., photodiodes, photo-modulated transistors, superconducting nanowire single-photon detectors (SNSPDs), photocathodes, and/or the like), light generators, and signal feedback and conditioning electronics each comprising of silicon-based processes. In some embodiments, the heterogeneous integration may provide broader capabilities including broadband wavelength detection, narrow and broadband light generation, and/or signal feedback and conditioning circuits. III-V semiconductors (e.g., Gallium Arsenide (GaAs), Gallium Nitride (GaN), phosphides, antimonides, and/or the like), II-VI semiconductors, and/or other wide bandgap semiconductors (e.g., Silicon Carbide (SiC), Diamond, or the like), perovskite oxides, dichalcogenides, transparent conducting oxides (TCOs) (e.g., Indium Tin Oxide (ITO), Zinc Oxide (ZnO), and their alloys), high-k dielectrics (materials with high dielectric constant), and/or metals may be leveraged or otherwise included in an heterogenous integrated system.

Monolithically integrated electronic and photonic systems according to various embodiments described herein may provide various advantages in various applications including, but not limited to, passive photonic feedback monitoring, multiplexed electrical readout, optical switch and amplitude modulation, and optical encoding of radio frequency (RF) and microwave drive signals.

With respect to passive photonic feedback monitoring, for integrated passive light delivery, a portion of the photonic circuit may be configured for real-time monitoring of system power delivery, loss variation, waveguide solarization (degradation of waveguide optical properties), and/or other metrics for consistent light delivery. The monitoring process may be paired with a feedback control system such as a proportional-integral-derivative (PID) controller, or a more sophisticated field programmable gate arrays (FPGA) based feedback controller (such as but not limited to an integrated digital servo) configured to provide real-time system tuning to maintain system homeostasis. The system may be configured to operate such that a PID controller (e.g., being electronic in contrast to photonic or optoelectronic) is leveraged to monitor a feedback optical signal, analyze the signal next to a set standard, and make adjustments to an optical modulator or some other tuning system responsible for adjusting light throughput.

The integrated digital servo may be leveraged for control of acousto-optic modulators and piezoelectric transducers and may be a more sophisticated and robust method of feedback and control of these modulators and sensors (e.g., in comparison to a PID controller) as it implements a digital signal processing (DSP) based feedback transfer function to the controllers. The electronics may include a cascade of analog and DSP control modules for feedback and control and may include variable-gain amplifiers (VGA), analog-to-digital (ADC or A/D) converters for ADC conversion, infinite impulse response (IIR) and PID filtration components, lock-in oscillators, and/or digital-to-analog (DAC or D/C) converters for DAC conversion. In some embodiments, an at-scale quantum computer with integrated photonics (e.g., passive and/or active photonic components), as described herein, may include integration of mixed signal systems in order to manage input/output (I/O) throughput and routing hardware traffic. Further, monolithic integration may be achieved by a silicon platform or heterogeneous integration may be performed if some component(s) was required for specialized or high-speed application in the control system.

Additionally, in some embodiments, direct monitoring and control of optical signals on-chip may enable in-situ optical multiplexing. Input coupling footprints, fiber-feedthrough and/or external beam delivery schemes may become untenable for the high optical I/O delivery needed in a full scale QCCD architecture. Example embodiments provide for efficient space utilization. For example, valuable space is not consumed by optical return lines that would be needed for an externally sourced control circuit. Further on-chip multiplexing, made possible with IC control, can also reduce phase delay/errors between beam lines due to splitting performed near the chip/ion. This keeps optical lines common for most of the delivery path which, when including the fiber length, can be on the order of meters. Further, direct monitoring may inform and improve decision-making in the event of failures. For example, monitors may be placed to elucidate likely failure events and provide real-time data as they occur. The historical monitoring data can be utilized to decide the necessary corrective actions, which may include utilizing redundant elements, attempting in-situ repairs, compensation via changes to system operation, and/or replacement of defective parts.

By way of example, and not intended to be limiting, a fully integrated 80 gate zone plus 80 measurement zone may require about 1200 optical I/Os (e.g., 15 cm of edge facet needed using conventional 127 microns fiber arrays), not including the necessary feedback lines 602 (See., e.g., FIG. 6) needed for external optical monitoring and control (e.g., about 2×, 30 cm total). In this regard, fiber feedthroughs and coupling footprints become a significant challenge for integrated photonic components without in-situ splitting and multiplexing. On-chip splitting, monitoring, and modulating according to example embodiments herein may reduce the number of fibers to about 250-400 fibers (3-5 cm of edge facet using conventional 127 microns fiber arrays). Particularly, on-chip monitoring may reduce the optical feedback lines. Additionally, on-chip, IC multiplexer may reduce electrical I/O for monitoring and electrooptic control and on-chip control may remove latency in control algorithms.

With respect to multiplexed electrical readout, the scale and complexity of trapped ion architectures utilizing integrated photonic components may necessitate consideration of highly sophisticated electrical read-out of signals. By way of example, a source-to-end photonic waveguide may require N signal monitoring points, such that a device with large M-fold photonic waveguide complexity would have even more vast N×M-fold electrical power and signal routing difficulties. According to example embodiments, multiplexed electrical power and readout provides a solution to this complexity by, for example, providing signal reduction by sensor-amplifier-multiplexer cascade. This provides the necessary optical allocation to the multizone trap while simultaneously allowing signal circuitry with minimized output lines for in-situ signal monitoring and conditioning (e.g., as discussed above).

According to various embodiments, the system includes integrated photodetection. A photodiode such as an APD and/or single-photon avalanche detector (SPAD) may be leveraged for integration with ion traps as it utilizes a process scheme that is aligned with the silicon processes generally used for ion trap fabrication. Moreover, supporting circuitry associated with the SPAD detectors could also benefit from integration. Example applications of such integration include biasing, multiplexing for on-trap multi-site detection, and signal conditioning post-photon acquisition. Detection circuits that may be leveraged include one or more of detector biasing, integrated multiplexing, and/or signal conditioning.

With respect to detector biasing, photodiodes may be operated in voltage or current mode, each with distinct advantages and disadvantages and each requiring dark current suppression and detector biasing and amplification, including possible transconductance from current to voltage depending, for example, on downstream signal requirements. According to various embodiments, a quench circuit and transconductance operational amplifier (OTA) may be leveraged which may benefit from integration with the detector for improved noise performance and to enable multiplexing. Additional logical switching of detector bias and circuit connectivity may be leveraged to localize detection chain response to those times during which photon detection is expected and desired. By eliminating undesired circuit response to stray light, example embodiments, can reduce use-based failures and nonlinear detection response.

With respect to integrated multiplexing, example embodiments may include a multiplexed cascade from the OTA/detector to downstream signal conditioning circuitry, which may be co-integrated in part or entirely on a chip. This co-integration may provide footprint and noise benefits as well as reduce the number of circuits and signal transfer lines from the dense ion trapping region. It may be generally unnecessary for all the detectors to acquire data simultaneously, such that N-fold detector multiplexing operational architecture can produce 1/N circuit and signal reduction. Such detection timing synchronization may necessitate tightly integrated logical control circuitry.

With respect to signal conditioning, a detector response is generally converted from the detection signal stream via ADC circuitry to logical detection events. An additional desirable feature of the signal electronics may include the ability to provide time localization of the detection events (e.g., and not just their cumulative count during a fixed time interval). Such time tagging or time binning capability may require coupling with logical circuitry to provide the full benefit of time resolved photon detection.

With respect to optical switch and amplitude modulation, based on, for example, the need for on-chip optical multiplexing, a need may exist for IC control of subsequent on-chip optical switches and/or electrooptic modulators for balancing power between photonic lines (e.g. single and two qubit gate operations), terminating light between optical operations (e.g. state-prep, measurement, gate, repump, photo-ionization, etc.), precise shaping of the optical pulse sequence (e.g., turn on time and on/off pulse train for optimized spectral response during gating, cooling, and other state manipulation operations), and/or switching to direct light to detectors for diagnostic photonic monitoring and/or direct light into redundant lines as corrective action following failures. Generally, such electrooptic modulation and switching may be achieved by transducing an electrical signal as a complex dielectric permittivity and/or a geometric dimensional change. This may then be combined with a resonant structure (e.g., ring resonators, Mach-Zehnder interferometers, plasmonic resonators, etc.) to promote an electrically activated coupling condition to direct light between routing lines. An example of such modulators that may be utilized include thermal modulator for when slow and tunable modulation is required (e.g. power balancing to a fixed value), for example. Another example of such modulators that may be utilized include piezoelectrically activated modulators that may be leveraged for fast and precise control modulation. In some embodiments, IC, such as an application specific integrated circuit (ASIC), may be leveraged to interface with these modulators to enforce logic-based switching with reduced electrical I/O (e.g., for a multiplexed scale application). Such components may include, but is not limited to, VGAs, DACs, and finite response filters.

With respect to optical encoding of radio frequency (RF) and microwave drive signals, parasitic effects can degrade the quality of the low frequency (non-optical) RF and microwave drive signals that are also delivered to the trapped ions. Direct monitoring of these precision controls can exacerbate the problem by adding more parasitic features. Instead, according to example embodiments, appropriately constructed electro-optical, acoustic, or other modulation features can encode the phase, frequency, and amplitude characteristics of these low frequency sources into the optical domain. This optically encoded information can then be returned to an appropriate detector where this diagnostic data can be read. For example, the highly stable infrared optical source, also needed for quantum operations, could pass through an electro-optic feature where it picks up sidebands from the trap RF drive. This diagnostic light may be returned to the lab, where it is heterodyned with the original high-stability infrared (IR) source, reading out the RF diagnostic data on heterodyne sidebands.

In various embodiments, a confinement apparatus system is provided. The confinement apparatus system may comprise a confinement apparatus configured for confining quantum objects. In various embodiments, the confinement apparatus system includes a confinement apparatus chip having electrical components disposed and/or formed thereon. In various embodiments, the electrical components disposed and/or formed on the confinement apparatus chip include electrodes configured for defining confinement regions within which quantum objects may be confined.

In various embodiments, the confinement apparatus chip includes one or more optical elements that are disposed and/or formed on the confinement apparatus chip and configured to provide respective optical manipulation signals to respective object locations defined within the confinement regions of the confinement apparatus and/or to receive/detect respective optical signals emitted by respective quantum objects located at respective object locations. In various embodiments, the one or more optical elements include passive and/or active optical elements.

In various embodiments, the confinement apparatus chip defines an apparatus plane. In various embodiments, the confinement apparatus system comprises one or more bridge chips that each define a respective bridge plane. The respective bridge planes are coplanar with the apparatus plane. Each of the one or more bridge chips may have one or more optical elements disposed and/or formed thereon and/or therein. In various embodiments, a bridge chip comprises zero or more inputs and one or more outputs. In various embodiments, a bridge chip is configured to provide manipulation signals and/or other optical signals to one or more optical elements disposed on the confinement apparatus chip, the bridge chip, and/or other chips (e.g., cloud chip, external chip, or the like). In various embodiments, a bridge chip may span regions that involve varying temperatures and/or pressures (e.g., within a cryogenic and/or vacuum chamber within which the confinement apparatus chip is disposed).

In various embodiments, the confinement apparatus system comprises one or more delivery chips. The delivery chip may have one or more optical elements disposed and/or formed thereon and/or therein. In various embodiments, a delivery chip is configured to provide manipulation signals and/or other optical signals to one or more optical elements disposed on the confinement apparatus chip, one or more bridge chips, the delivery chip, and/or defined positions of the confinement apparatus.

In various embodiments, a delivery chip may be disposed within the cryogenic and/or vacuum chamber within which the confinement apparatus chip is disposed or external thereto. In various embodiments, delivery chips may be configured in various physical orientations. For example, a delivery chip defines a delivery chip plane which may be disposed with various orientations with respect to the apparatus plane. For example, in an example embodiment, a delivery chip is mounted to a wall and/or shielding surface of the cryogenic and/or vacuum chamber within which the confinement apparatus chip is disposed.

An example of a delivery chip is a cloud chip. In various embodiments, the confinement apparatus system comprises one or more cloud chips that each define a respective cloud plane that is parallel to the apparatus plane but not coplanar with the apparatus plane. Each of the one or more cloud chips may have one or more optical elements disposed and/or formed thereon and/or therein.

In various embodiments, the confinement apparatus system comprises one or more external chips (e.g., one or more photonic integrated circuits (PICs)). In some embodiments, at least a portion (e.g., some or all) of each of the optical elements (e.g., opto-electronic sensors, light sources (e.g., lasers, LEDs, or the like), photonic components (e.g., passive photonic components, active photonic components) and/or electronic elements of the confinement apparatus system are disposed and/or formed on the confinement apparatus chip. Alternatively or additionally, in some embodiments, at least a portion (e.g., some or all) of each of the optical elements (e.g., opto-electronic sensors, light sources (e.g., lasers, LEDs, or the like), photonic components, and/or the like) and/or electronic elements of the confinement apparatus system are disposed and/or formed on a bridge chip of the confinement apparatus system. Alternatively or additionally, in some embodiments, at least a portion (e.g., some or all) of each of the optical elements (e.g., opto-electronic sensors, light sources (e.g., lasers, LEDs, or the like), photonic components, and/or the like) and/or electronic elements of the confinement apparatus system are disposed on a cloud chip of the confinement apparatus system. Alternatively or additionally, in some embodiments, at least a portion (e.g., some or all) of the optical elements (e.g., opto-electronic sensors, light sources (e.g., lasers, LEDs, or the like), photonic components, and/or the like) and/or electronic elements of the confinement apparatus system are disposed on an external chip of the confinement apparatus system. In this regard, in some embodiments, the confinement apparatus system may comprise one or more ancillary chips (e.g., bridge chips, cloud chips, external chips, and/or other chips). As used herein, an ancillary chip refers to any distinct chip (relative to the confinement apparatus chip) that includes co-integrated photonics-electronics (as described herein) configured to interface with a confinement apparatus chip.

In various embodiments, a bridge chip and/or delivery chip may be disposed in a region of substantially constant temperature and/or pressure conditions. For example, the bridge chip and/or delivery chip may be disposed within an action region of the cryogenic and/or vacuum chamber such that the bridge chip and/or delivery chip is operated under cryogenic and/or ultra-high vacuum conditions. In various embodiments, the confinement apparatus chip is disposed within the action region of the cryogenic and/or vacuum chamber and configured to be operated under cryogenic and/or ultra-high vacuum conditions. The bridge chip and/or delivery chip may be disposed in an intermediary area of the cryogenic and/or vacuum chamber (e.g., within the cryogenic and/or vacuum chamber but in an intermediate region thereof that experiences intermediate temperatures and/or pressures that are between ambient temperature and/or pressure outside of the cryogenic and/or vacuum chamber and the very low cryogenic temperatures and ultra-high vacuum conditions within the action region of the cryogenic and/or vacuum chamber). In an example embodiment, a delivery chip may be disposed outside of the cryogenic and/or vacuum chamber.

In various embodiments, a bridge chip and/or delivery chip may be partially disposed in and/or extend across one or more regions of the cryogenic and/or vacuum chamber. As used herein, the regions of the cryogenic and/or vacuum chamber include the action region of the cryogenic and/or vacuum chamber (e.g., having very low temperatures and ultra-high vacuum conditions), the intermediate region of the cryogenic and/or vacuum chamber (e.g., having intermediate temperatures and intermediate pressures), and an ambient region (directly) outside of the cryogenic and/or vacuum chamber (e.g., having ambient/room temperatures and/or ambient/atmospheric pressure). For example, a portion of a bridge chip and/or delivery chip may be disposed in the action region of the cryogenic and/or vacuum chamber and a portion of the bridge chip may be disposed in the intermediate region of the cryogenic and/or vacuum chamber.

In various embodiments, the confinement apparatus chip defines a plurality and/or an array of defined positions. For example, the confinement apparatus chip may be configured such that when appropriate voltage signals are applied to electrical components (e.g., electrodes) thereof, an electric potential is generated that is configured to confine quantum objects at the defined positions. In various embodiments, a sub-array of defined positions may be configured for performing a particular function (e.g., a reading function, performance of a single qubit or multi-qubit (e.g., two qubit) gate, and/or the like. In various embodiments, the optical elements disposed on the confinement apparatus chip, bridge chip(s), delivery chip(s), and/or external chip(s) that are configured for performance of the particular function are arrayed on their respective chips/substrates accordingly.

In various embodiments, the confinement apparatus system is part of a system (e.g., quantum processor, quantum computer, and/or other atomic and/or quantum system) comprising a signal management system. For example, in various embodiments, a QCCD-based quantum system is provided comprising a confinement apparatus and a signal management system wherein one or more optical elements of the signal management system are formed and/or disposed on the confinement apparatus chip (e.g., on which the confinement apparatus is formed and/or disposed), a bridge chip, a cloud chip, and/or an external chip of the confinement apparatus system. For example, the system may comprise a signal management system configured to generate, provide, and/or control parameters (e.g., wavelength, intensity, phase, polarization, and/or the like) of electromagnetic signals applied to one or more positions within the confinement apparatus system for the purpose of controlling the quantum state of one or more quantum objects confined by the confinement apparatus. In various embodiments, one or more of the components of the signal management system (active and/or passive components) are formed and/or disposed on the confinement apparatus chip itself, a bridge chip, a cloud chip, and/or an external chip.

For example, the signal management system comprises active and/or passive optical elements respectively configured for generating, providing, collecting/detecting, and/or controlling parameters of manipulation signals applied to various positions defined by the confinement apparatus. In various embodiments, the optical elements of the signal management system comprise one or more diffractive optical elements, passive metasurfaces, active metasurfaces, optical modulators, low loss waveguides, amplifiers, on-chip lasers, photodetectors, grating couplers, beam splitters, edge couplers, optical local oscillators, tapers, reference cavities, light absorbing structures, anti-reflection coatings, optical routing elements, resonators, and/or the like. In various embodiments, various optical elements of the signal management system have electronic components (e.g., control and signal processing electronics) associated therewith (e.g., the optical elements may be active optical elements with electrically controlled aspects) and other optical elements of the signal management system do not have electronic components associated therewith (e.g., the optical elements may be passive optical elements and/or active elements controlled via a technique other than electric signal-based control). In various embodiments, the electronic components associated with the optical elements are disposed on the same chip as the optical elements. For example, in some embodiments, the optical elements and electronic components associated therewith may be disposed on the confinement apparatus chip. As another example, in some embodiments, the optical elements and electronic components associated therewith may be disposed on the same bridge chip. As yet another example, in some embodiments, the optical elements and electronic components associated therewith may be disposed on the same cloud chip. As yet further example, in some embodiments, the optical elements and electronic components associated therewith may be disposed on the same external chip.

In various embodiments, a quantum object is a neutral or ionic atom; neutral, ionic, or multipole molecule; quantum particle; quantum dot; and/or other object having quantum states that can be manipulated and/or controlled. The quantum object may be qubit quantum object of a quantum object crystal comprising two or more quantum objects, with, in an example embodiment, the two or more quantum objects of the quantum object crystal comprising, for example, ions of at least two different atomic numbers. In an example embodiment, the confinement apparatus system comprises an ion trap (e.g., a surface ion trap, Paul trap, and/or the like) having co-integrated photonics and electronic circuitry. For example, the ion trap may be formed, defined, and/or disposed on a confinement apparatus chip and may be associated with one or more bridge chips, one or more cloud chips, and/or one or more external chips. At least a portion (e.g., some or all) of the optical elements (e.g., opto-electronic sensors, light sources, photonic components, and/or the like) and electronic components leveraged by the ion trap may be disposed on one or more of the confinement apparatus chip itself, a bridge chip(s) associated with the confinement apparatus chip, a cloud chip(s) associated with the confinement apparatus chip, or an external chip associated with the confinement apparatus chip. For example, in some embodiments, all of the optical elements (e.g., opto-electronic sensors, light sources, photonic components, and/or the like) and electronic components leveraged by the ion trap may be disposed on the confinement apparatus chip, a bridge chip associated with the confinement apparatus chip, a cloud chip associated with the confinement apparatus chip, or an external chip associated with the confinement apparatus chip. As another example, in some embodiments, a set or group of the optical elements (e.g., opto-electronic sensors, light sources, photonic components, and/or the like) and electronic components leveraged by the ion trap may be disposed on the confinement apparatus chip, a bridge chip associated with the confinement apparatus chip, a cloud chip associated with the confinement apparatus chip, or an external chip associated with the confinement apparatus chip.

Example Quantum Computing System Comprising a Confinement Apparatus with Integrated Electronics and Photonics.

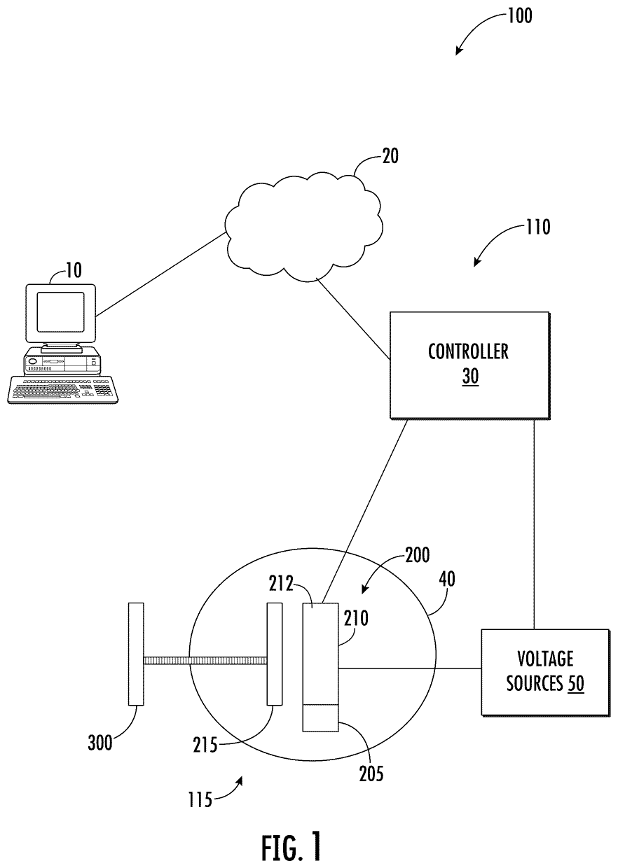

FIG. 1 provides a schematic diagram of an example quantum computing system 100 comprising a confinement apparatus system 200, in accordance with an example embodiment. The depiction of the example quantum computing system 100 and the example confinement apparatus system 200 are not intended to limit or otherwise confine the embodiments described and contemplated herein to any particular configuration of components or systems, nor are they intended to exclude any alternative configurations or systems.

The confinement apparatus system 200 comprises a confinement apparatus chip 210. The confinement apparatus system 200 may further include one or more bridge chips 205 and/or one or more cloud chips 215. It will be appreciated that in some other embodiments, the confinement apparatus system 200 may not include a bridge chip and/or may not include a cloud chip.

In various embodiments, the confinement apparatus system 200 is disposed within a cryogenic and/or vacuum chamber 40. For example, the confinement apparatus chip 210, one or more bridge chips 205, and/or one or more cloud chips 215 may be disposed within the cryogenic and/or vacuum chamber 40. In various embodiments, electrical elements, such as electrodes, that define and/or form the confinement apparatus 212 are formed and/or disposed on the confinement apparatus chip 210.

In various embodiments, the quantum computing system 100 comprises a signal management system. In various embodiments the signal management system comprises a plurality of optical elements formed and/or disposed on and/or in the confinement apparatus chip 210, bridge chip(s) 205, and/or cloud chip(s) 215. At least a portion (e.g., some or all) of the plurality of optical elements may be disposed and/or formed in a photonic layer of the confinement apparatus chip 210, a photonic layer of the bridge chip(s) 205, and/or a photonic layer of cloud chip(s) 215 as described further below. Additionally, in various embodiments, one or more of the plurality of optical elements may be disposed and/or formed in a monitoring-control layer of the confinement apparatus chip 210, a monitoring-control layer of the bridge chip(s) 205, and/or a monitoring-control layer of cloud chip(s) 215 as described further below.

In various embodiments, the confinement apparatus chip 210 includes a photonic layer having one or more optical elements (e.g., opto-electronic sensors, light sources, photonic components, and/or the like) disposed and/or formed thereon and/or therein, a monitoring-control layer having one or more electronic elements (e.g., control and signal processing electronics) disposed and/or formed thereon and/or therein, and an isolation layer (e.g., an electrical and optical isolation layer) disposed between the photonic layer and the monitoring-control layer. Additionally, the monitoring-control layer may have one or more optical elements (e.g., photodetectors, or the like) disposed and/or formed thereon and/or therein. In some embodiments, the confinement apparatus chip 210 may not include an isolation layer between the photonic layer and the monitoring-control layer. In some embodiments, the photonic layer of a confinement apparatus chip 210 may comprise a plurality of sub-layers that define the photonic layer of the confinement apparatus chip 210. In some embodiments, the monitoring-control layer of a confinement apparatus 212 may comprise a plurality of sub-layers that define the monitoring-control layer of the confinement apparatus 212. In some embodiments, the confinement apparatus chip 210 includes one or more other layers formed thereon. For example, in some embodiments, the confinement apparatus 212 includes a layer comprising anti-reflective coating and/or one or more other components of the confinement apparatus chip 210 and/or confinement apparatus system 200.

In various embodiments, the confinement apparatus chip 210 defines an apparatus plane. In some embodiments, the confinement apparatus system 200 comprises one or more bridge chips 205 that each define a respective bridge plane. The respective bridge planes may be coplanar with the apparatus plane. In some embodiments, each of the one or more bridge chips 205 is embodied as an integrated circuit comprising a photonic layer having one or more optical elements (e.g., opto-electronic sensors, light sources, photonic components, and/or the like) disposed and/or formed thereon and/or therein, a monitoring-control layer having one or more electronic elements disposed and/or formed thereon and/or therein, and an isolation layer (e.g., electrical and optical isolation layer) disposed between the photonic layer of the bridge chip and the monitoring-control layer of the bridge chip. Additionally, the monitoring-control layer may have one or more optical elements (e.g., photodetectors, or the like) disposed and/or formed thereon and/or therein. In some embodiments, the bridge chip 205 may not include an isolation layer between the photonic layer and the monitoring-control layer. In some embodiments, the photonic layer of a bridge chip 205 may comprise a plurality of sub-layers that define the photonic layer of the bridge chip 205. In some embodiments, the monitoring-control layer of a bridge chip 205 may comprise a plurality of sub-layers that define the monitoring-control layer of the bridge chip 205. In some embodiments, the bridge chip 205 includes one or more other layers formed thereon. For example, in some embodiments, the bridge chip 205 includes a layer comprising anti-reflective coating and/or one or more other components of the bridge chip 205 and/or confinement apparatus system 200.

In some embodiments, the confinement apparatus system comprises one or more cloud chips 215 that each define a respective cloud plane that is parallel to the apparatus plane but not coplanar with the apparatus plane. In various embodiments, each of the one or more cloud chips 215 may be embodied as an integrated circuit comprising a photonic layer having one or more optical elements (e.g., opto-electronic sensors, light sources, photonic components, and/or the like) disposed and/or formed thereon and/or therein, a monitoring-control layer having one or more electrical/electronic elements disposed and/or formed thereon and/or therein, and an isolation layer (e.g., electrical and optical isolation layer) disposed between the photonic layer of the cloud chip 215 and the monitoring-control layer of the cloud chip 215. Additionally, the monitoring-control layer may have one or more optical elements (e.g., photodetectors, or the like) disposed and/or formed thereon and/or therein. In some embodiments, the cloud chip 215 may not include an isolation layer between the photonic layer and the monitoring-control layer. In some embodiments, the photonic layer of a cloud chip 215 may comprise a plurality of sub-layers that define the photonic layer of the cloud chip 215. In some embodiments, the monitoring-control layer of a cloud chip 215 may comprise a plurality of sub-layers that define the monitoring-control layer of the cloud chip 215. In some embodiments, the cloud chip 215 includes one or more other layers formed thereon. For example, in some embodiments, the cloud chip 215 includes a layer comprising anti-reflective coating and/or one or more other components of the cloud chip 215 and/or confinement apparatus system 200.

In this regard, the signal management system may comprise one or more optical elements formed and/or disposed on and/or in a photonic layer of the confinement apparatus 212. Alternatively or additionally, the signal management system may comprise one or more optical elements formed and/or disposed on and/or in a photonic layer of the bridge chip(s) 205. Alternatively or additionally, the signal management system may comprise one or more optical elements formed and/or disposed on and/or in the photonic layer of the cloud chip(s) 215. Alternatively or additionally, in some embodiments, the signal management system comprises one or more optical elements formed and/or disposed on and/or in one or more external chips 300 that are external to the cryogenic and/or vacuum chamber 40. In some embodiments, the one or more optical elements formed and/or disposed on and/or in the one or more external chips 300 may be coupled to one or more components (e.g., optical elements, electronic elements, and/or the like) formed and/or disposed on and/or in the confinement apparatus chip 210 (e.g., via optical fibers, free space optics, or the like). Alternatively or additionally, in various embodiments, the one or more optical elements formed and/or disposed on and/or in the one or more external chips 300 may be coupled to one or more components (e.g., optical elements, electronic components, and/or the like) formed and/or disposed on and/or in a bridge chip 205 and/or a cloud chip(s) 215 (e.g., via optical fibers, free space optics, and/or the like).

In various embodiments, the quantum computing system 100 comprises a computing entity 10 and a quantum computer 110. In various embodiments, the quantum computer 110 comprises a controller 30 and a quantum processor 115. In various embodiments, the quantum processor comprises a cryogenic and/or vacuum chamber 40 enclosing a confinement apparatus system 200 (e.g., an ion trap), one or more external chips 300 comprising components of the signal management system, one or more voltage sources 50 configured to provide voltage signals to the electrical components of the confinement apparatus system 200.

In various embodiments, the cryogenic and/or vacuum chamber 40 is a temperature and/or pressure-controlled chamber. For example, the quantum computing system 100 may comprise vacuum and/or temperature control components that are operatively coupled to the cryogenic and/or vacuum chamber 40.

In various embodiments, the quantum computer 110 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding electrode elements (e.g., electrodes) of the confinement apparatus 212, in an example embodiment. For example, the electric and/or electromagnetic field formed at least in part by applying the voltage signals generated by the voltage source 50 to the electrical elements of the confinement apparatus cause and/or form the confinement region(s) of the confinement apparatus.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control and/or in electrical communication with the voltage sources 50, cryogenic system and/or vacuum system controlling the temperature and/or pressure within the cryogenic and/or vacuum chamber 40, manipulation sources, photodetectors, and/or other systems controlling various environmental conditions (e.g., temperature, pressure, and/or the like) within the cryogenic and/or vacuum chamber 40 and/or configured to manipulate and/or cause a controlled evolution of quantum states of one or more quantum objects within the confinement apparatus. For example, the controller 30 may cause a controlled evolution of quantum states of one or more quantum objects within the confinement apparatus to execute a quantum circuit and/or algorithm. For example, the controller 30 may cause a reading procedure comprising coherent shelving to be performed, possibly as part of executing a quantum circuit and/or algorithm. In various embodiments, the quantum objects confined within the confinement apparatus are used as qubits of the quantum processor 115 and/or quantum computer 110.

### Confinement Apparatus

In various embodiments, the confinement apparatus system 200 comprises a confinement apparatus 212. The confinement apparatus 212 comprises a plurality of electrical elements such as electrodes, in an example embodiment, that are configured to generate a confining potential. In various embodiments, the plurality of electrodes of the confinement apparatus 212 are formed and/or disposed on a confinement apparatus chip 210. For example, the controller 30 may control the voltage sources 50 to provide electrical signals to the electrodes of the confinement apparatus 212 such that the electrodes generate a confining potential. The confining potential is configured to confine a plurality of quantum objects within a confinement volume defined by the confinement apparatus 212. For example, in an example embodiment, the confinement apparatus 212 is a surface ion trap and the confinement volume is a volume located proximate the surface of the surface ion trap. In various embodiments, the electrodes and/or confining potential are configured to define a plurality of defined positions within the confinement volume.

In various embodiments, the voltage sources 50 provide respective electrical signals to the respective electrical elements (e.g., respective electrodes of sequences of electrodes) of the confinement apparatus 212, such that a confining potential is formed. Based on the contours and time evolution of the confining potential (controlled by the controller 30 via controlling the operation of the voltage sources 50) one or more quantum objects are confined at respective defined positions, moved between defined positions and/or the like. When a quantum object is located at a defined position, one or more functions (e.g., quantum computing functions) may be performed on the quantum object.

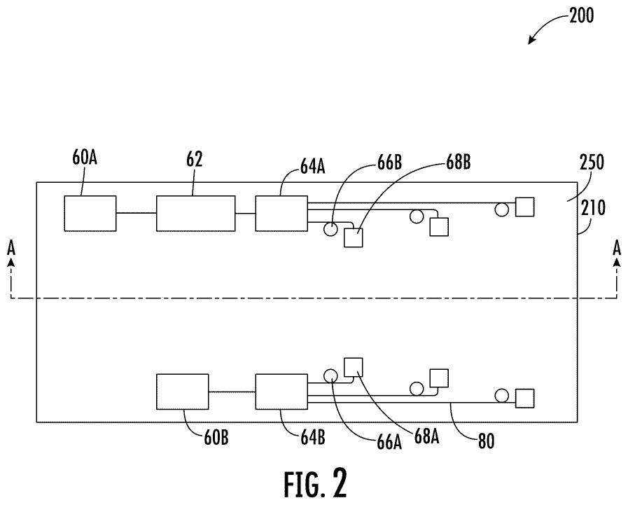

FIG. 2 provides a top view of a portion of a confinement apparatus 212. Specifically, FIG. 2 shows example optical elements that may be disposed and/or formed on, near, and or in a confinement apparatus chip 210 in an example embodiment. For example, as shown in FIG. 2, one or more manipulation sources (e.g., 60A, 60B), amplifiers 62, beam splitters (e.g., 64A, 64B), optical modulators (e.g., 66A, 66B), signal manipulation elements (e.g., 68A, 68B), waveguides 80 may be formed and/or disposed on, near, and/or in the confinement apparatus chip 210. In some embodiments, the confinement apparatus chip 210 may not include one or more of the above example optical elements and/or may include other optical elements.

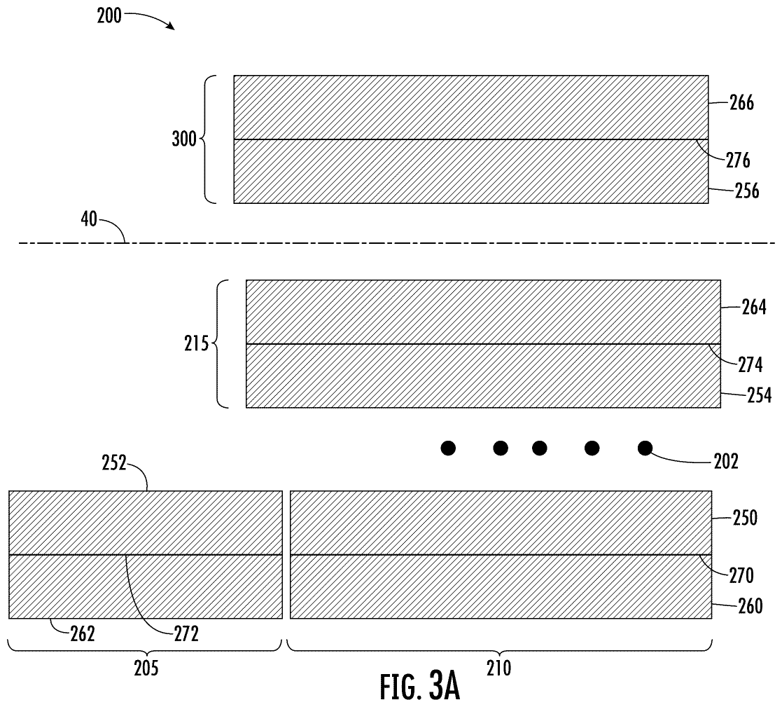

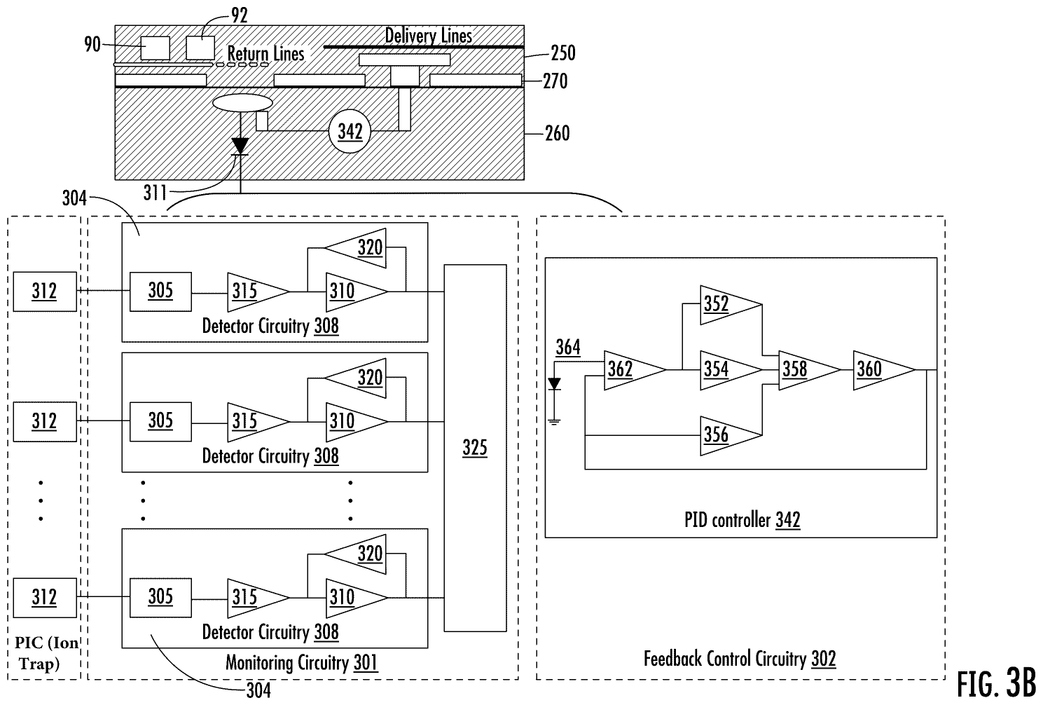

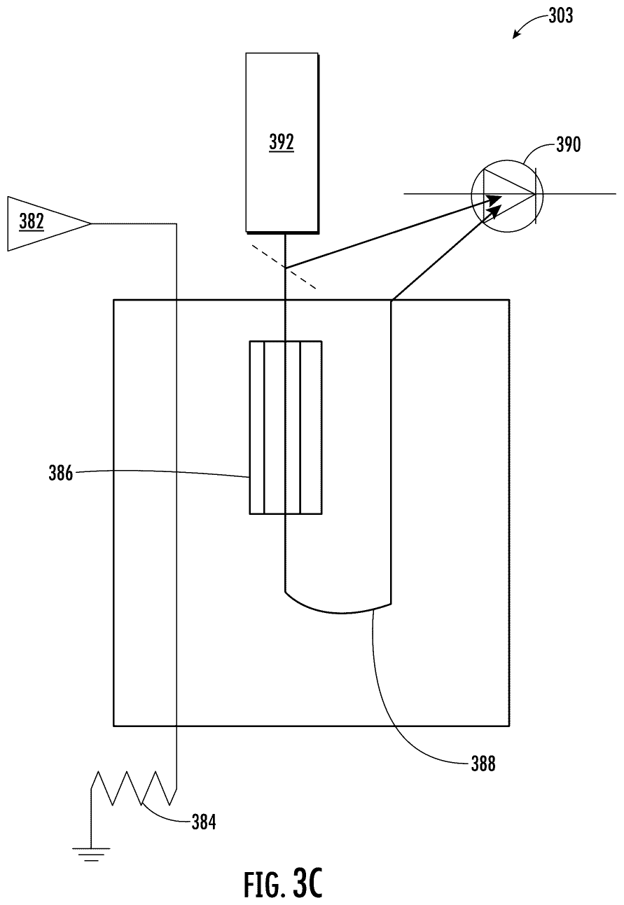

FIG. 3A provides a schematic cross-section view of a confinement apparatus system 200. In some embodiments, the confinement apparatus system 200, in addition to the confinement apparatus 212 (e.g., confinement apparatus chip 210 thereof), may include one or more of a bridge chip 205, a cloud chip 215, or an external chip 300. In some embodiments, the confinement apparatus system 200 may not include any of a bridge chip 205, a cloud chip 215, or an external chip 300. In some embodiments, at least one of the confinement apparatus chip 210, bridge chip 205, cloud chip 215, or an external chip 300 may include a photonic layer, where the photonic layer may include one or more optical elements. For example, the optical elements described above with respect to FIG. 2 may be disposed on, near, and/or in one or more photonic layers, where the one or more photonic layers may include at least one of a photonic layer of a confinement apparatus chip 210, a photonic layer of a bridge chip 205, a photonic layer of a cloud chip 215, or a photonic layer of an external chip 300. For example, the confinement apparatus system 200 may include a plurality of optical elements distributed across one or more of a confinement apparatus chip 210, a bridge chip 205, a cloud chip 215, or an external chip 300. Examples of such optical elements include manipulation sources, amplifiers, beam splitters, optical modulators, signal manipulation elements, waveguides, directional couplers, input couplers, grating couplers, edge couplers, directionally coupled pickoffs, polarization filters, interferometers, spatial filters, tapers, reference cavities, light absorbing structures, routing elements, resonators (e.g., ring-resonators), and/or the like. In some embodiments, the optical modulators may comprise acousto-optic modulator(s), electro-optic modulator(s), and/or other optical modulators. It would be appreciated that the optical modulators may comprise any type of modulator. In some embodiments, a feedback control circuitry (described further below) may be configured to control the optical modulators. The feedback control circuitry may be disposed on, near, and/or in the confinement apparatus chip 210, bridge chip 205, cloud chip 215, or an external chip 300. For example, at least one of the confinement apparatus chip 210, bridge chip 205, cloud chip 215, or an external chip 300 may include a monitoring-control layer, where the monitoring-control layer includes a feedback control circuitry.

As shown in FIG. 3A, in some embodiments, the confinement apparatus chip 210 may include a photonic layer 250, a monitoring-control layer 260 disposed below the photonic layer 250, and an isolation layer 270 disposed between the photonic layer 250 and the monitoring-control layer 260. For example, a monitoring-control layer 260 may be formed and/or disposed on a substrate, the isolation layer 270 may be formed and/or disposed on the monitoring-control layer 260, and a photonic layer 250 may be formed and/or disposed on the monitoring-control layer 260. For example, the confinement apparatus chip 210 may comprise a substrate having a photonic layer, a monitoring-control layer, and/or an isolation layer formed and/or disposed thereon. In some embodiments, the substrate is a silicon (Si) substrate such as a silicon wafer, an aluminum oxide (Al2O3) substrate, a silicon carbide (SiC) substrate, or the like. In some embodiments, the substrate may be an optically transparent substrate such as a glass substrate, sapphire substrate, or the like. For example, active elements may be transferred to the optically transparent substrate. In some embodiments, the confinement apparatus chip 210 may not include an isolation layer 270 disposed between the photonic layer 250 and the monitoring-control layer 260. In some embodiments, the confinement apparatus chip 210 may include electronic and photonic interconnections between layers (e.g., photonic layer 250, monitoring-control layer 260, isolation layer 270, and/or other layers) of the confinement apparatus chip 210 via one or more vias, including between the photonic layer 250 and the monitoring-control layer 260.

In various embodiments, the confinement apparatus chip 210 defines an apparatus plane, and a bridge chip 205 may define a respective bridge plane that is coplanar with the apparatus plane. In some embodiments, a bridge chip 205 may include a photonic layer 252 a monitoring-control layer 262, and an isolation layer 272 disposed between the photonic layer 252 and the monitoring-control layer 262 of the respective bridge chip 205. For example, a monitoring-control layer 262 may be formed and/or disposed on a substrate, an isolation layer 272 may be formed and/or disposed on the monitoring-control layer 262, and a photonic layer 252 may be formed and/or disposed on the monitoring-control layer 262. For example, the bridge chip 205 may comprise a substrate having a photonic layer, a monitoring-control layer, and/or an isolation layer formed and/or disposed thereon. In some embodiments, the substrate is a silicon substrate such as a silicon wafer, an aluminum oxide substrate, a silicon carbide substrate, or the like. In some embodiments, the substrate may be an optically transparent substrate such as a glass substrate, sapphire substrate, or the like. For example, active elements may be transferred to the optically transparent substrate. In some embodiments, a bridge chip 205 may not include an isolation layer 272 disposed between the photonic layer 252 and the monitoring-control layer 262. In some embodiments, the bridge chip 205 may include electronic and photonic interconnections between layers (e.g., photonic layer 252, monitoring-control layer 262, isolation layer 272, and/or other layers) of the bridge chip 205 via one or more vias.

In various embodiments, the cloud chip 215 may be a delivery chip that defines a cloud plane that is substantially parallel to the apparatus plane but not coplanar with the apparatus plane. In some embodiments, the cloud chip 215 may include a photonic layer 254, a monitoring-control layer 264, and an isolation layer 274 disposed between the photonic layer 254 and the monitoring-control layer 264 of the respective cloud chip. For example, a monitoring-control layer 264 may be formed and/or disposed on a substrate, an isolation layer 274 may be formed and/or disposed on the monitoring-control layer 264, and a photonic layer 254 may be formed and/or disposed on the monitoring-control layer 264. For example, the cloud chip 215 may comprise a substrate having a photonic layer, a monitoring-control layer, and/or an isolation layer formed and/or disposed thereon. In some embodiments, the substrate is a silicon substrate such as a silicon wafer, an aluminum oxide substrate, a silicon carbide substrate, or the like. In some embodiments, the substrate may be an optically transparent substrate such as a glass substrate, sapphire substrate, or the like. For example, active elements may be transferred to the optically transparent substrate. In some embodiments, a cloud chip 215 may not include an isolation layer 274 disposed between the photonic layer 254 and the monitoring-control layer 264. The cloud chip 215 may include electronic and photonic interconnections between layers (e.g., photonic layer 254, monitoring-control layer 264, isolation layer 274, and/or other layers) via one or more vias.

In some embodiments, the external chip 300 may include a photonic layer 256, a monitoring-control layer 266, and an isolation layer 276 disposed between the photonic layer 256 and the monitoring-control layer 266 of the external chip 300. For example, a monitoring-control layer 266 may be formed and/or disposed on a substrate such as a silicon wafer, an isolation layer 276 may be formed and/or disposed on the monitoring-control layer 266, and a photonic layer 256 may be formed and/or disposed on the monitoring-control layer 266. For example, the external chip 300 may comprise a substrate having a photonic layer, a monitoring-control layer, and/or an isolation layer formed and/or disposed thereon. In some embodiments, the substrate is a silicon substrate such as a silicon wafer, an aluminum oxide substrate, a silicon carbide substrate, or the like. In some embodiments, the substrate may be an optically transparent substrate such as a glass substrate, sapphire substrate, or the like. For example, active elements may be transferred to the optically transparent substrate. In some embodiments, an external chip 300 may not include an isolation layer 276 disposed between the photonic layer 256 and the monitoring-control layer 266. In some embodiments, the external chip 300 may include electronic and photonic interconnections between layers (e.g., the photonic layer 256, monitoring-control layer 266, isolation layer 276, and/or other layers) of the external chip via one or more vias. In an example embodiment where the external chip 300 includes manipulation sources, the manipulation signals generated by the manipulation sources may be provided to defined positions located within the cryogenic and/or vacuum chamber 40. In some embodiments, the manipulation sources may be provided via free space optics and/or optical fibers (or other waveguides) through a window or pass through formed in the cryogenic and/or vacuum chamber 40.

The depiction of the example confinement apparatus system 200 in FIG. 3A is not intended to limit or otherwise confine the embodiments described and contemplated herein to any particular configuration or elements, nor is it intended to exclude any alternative configurations. For example, while FIG. 3A shows a confinement apparatus chip 210, a bridge chip 205, a cloud chip 215, and an external chip 300, the confinement apparatus system 200 may omit one or more of the bridge chip 205, the cloud chip 215, or the external chip 300 in some embodiments. Further, while FIG. 3A shows each of the confinement apparatus chip 210, the bridge chip 205, the cloud chip 215, and the external chip 300 as comprising a photonic layer and a monitoring layer, at least one of the confinement apparatus chip 210, the bridge chip 205, the cloud chip 215, and the external chip 300 may not include a photonic layer and/or may not include a monitoring layer in some embodiments.

In various embodiments, one or more optical elements, disposed and/or formed on and/or in a photonic layer may be configured for use in performing one or more functions on one or more quantum objects 202 disposed at respective defined positions. Further, in various embodiments, one or more optical elements, disposed and/or formed on and/or in a photonic layer may be configured for use in performing one or more functions related to optoelectronic monitoring and feedback control as further described below.

In various embodiments, the manipulation source(s) may comprise one or more lasers (e.g., optical lasers, microwave sources, and/or the like). In various embodiments, a manipulation source may be configured to generate a manipulation signal having a respective characteristic wavelength in the microwave, infrared, visible, or ultraviolet portion of the electromagnetic spectrum. For example, the respective characteristic wavelength may be configured to cause and/or control one or more particular quantum state evolutions of a quantum object. In various embodiments, a manipulation signal may be configured to manipulate and/or cause a controlled quantum state evolution of one or more quantum objects confined by the confinement apparatus system 200. For example, in an example embodiment, wherein the one or more manipulation sources comprise one or more lasers, the lasers may provide one or more laser beams to defined positions where respective quantum objects 202 are positioned. In various embodiments, a manipulation source may generate a manipulation signal that is provided to one or more defined positions in confinement apparatus system 200 via one or more of beam splitters, waveguides, signal manipulation elements, directional couplers, grating couplers, input couplers, and/or the like. In an example embodiment, one or more optical modulators are configured to control which defined positions of one or more defined positions upon which the manipulation signal is incident.

In various embodiments, the beam splitter(s) may be configured to handle optical beams of sufficient power for performing the respective functions of the quantum computer while exhibiting minimal power absorption. In various embodiments, the optical modulator(s) may comprise one or more on-chip modulators; modulators with integrated detectors (e.g., a photodiode, or the like) and configured to stabilize optical beam parameters such as intensity, phase, and/or frequency; and/or other optical modulators. In various embodiments, at least one optical modulator may be a switching modulator. The optical modulator(s) may be configured to handle optical beams of sufficient power for performing the respective functions of the quantum computer while exhibiting minimal power absorption.

In various embodiments, the signal manipulation element(s) may comprise one or more of diffractive optics elements (DOEs), such as lenses, mirrors, and/or the like; passive metamaterial arrays; active metamaterial arrays; and/or the like. In an example embodiment, a signal manipulation element may be configured to focus a manipulation signal onto a defined position such that the optical signal delivered to a quantum object 202 located at the defined position is sufficient to perform the corresponding function of the quantum computer while reducing the power density within one or more corresponding waveguides configured to deliver the manipulation signal to the respective signal manipulation element. In various embodiments, the waveguide(s) may be configured to transmit optical beams (e.g., manipulations signals) between various optical elements of the signal management system. In an example embodiment, the waveguide(s) may be loss waveguides.

In various embodiments, the coupler(s) may comprise one or more directional couplers, input couplers, grating couplers, edge couplers, tapers, and/or the like. In various embodiments, one or more of the coupler(s) may be used to couple manipulation signals into one or more waveguides and/or outcouple manipulation signals towards a defined position. For example, in an example embodiment, the coupler(s) may include edge couplers for coupling manipulations signals into waveguides from one or more optical fibers. As another example, in an example embodiment, the coupler(s) may include grating couplers for outcoupling manipulation signals toward a defined position. In an example embodiment, one or more grating couplers may be configured to deliver a focused beam of light to a respective defined position at a respective wavelength, angle, and polarization (e.g., transverse electric (TE) or transverse magnetic (TM)). For example, a grating coupler may focus the manipulation signal onto the defined position such that the optical signal delivered to a quantum object located at the defined position is sufficient to perform the corresponding function of the quantum computer while reducing the power density within one or more corresponding waveguides configured to deliver the manipulation signal to the coupler. In an example embodiment, the coupler(s) may include two-dimensional grating couplers that are capable of delivering circularly polarized manipulation signals to defined positions. In various embodiments, the coupler(s) may be leveraged to facilitate monitoring of optoelectronic performance and/or for providing feedback control. In various embodiments, one or more optical elements, disposed and/or formed on and/or in a photonic layer are configured for use in performing one or more functions related to optoelectronic monitoring.

In various embodiments, a photonic layer may include optical loop-backs comprising one or more waveguides, one or more input couplers, and/or one or more directionally coupled pickoffs 90 (See FIG. 3B) running parallel to waveguide lines. The optical loop-backs, one or more directional couplers, and/or one or more grating couplers may be configured to, individually or collectively, deliver optical signal (e.g., corresponding to optical power/light, etc.) to designated integrated circuit regions within the confinement apparatus system 200 to monitor optical power. For example, the optical loop-backs, one or more directional couplers, and/or one or more grating couplers may be configured, individually or collectively, to re-direct optical signal generated by the manipulation sources to a monitoring-control layer for optical power monitoring. For example, one or more of directional couplers and/or grating couplers formed and/or disposed on and/or in a photonic layer may be configured to direct optical signal, vertically, to designated positions, such as designated positions within a monitoring-control layer.

In various embodiments, one or more passive optical elements (e.g., polarization filters, resonators 92 (See FIG. 3B) such as ring resonators, interferometers, spatial filters, and/or or the like) formed and/or disposed on a photonic layer along with the waveguide lines may be configured to monitor optical performance (e.g., optical performance of one or more optical elements). For example, one or more polarization filters, one or more resonators 92 (See, e.g., FIG. 3B), or more interferometers, and/or one or more spatial filters formed and/or disposed on a photonic layer may be configured for monitoring of polarization, phase, frequency stability, spatial intensity distribution, respectively.

FIG. 3B provides a schematic cross-section view of a confinement apparatus system showing an example schematic of a monitoring circuitry and an example schematic of a feedback control circuitry thereof, according to an example embodiment.

In various embodiments, a monitoring-control layer (e.g., monitoring-control layer in a confinement apparatus chip 210, monitoring-control layer in a bridge chip 205, monitoring-control layer of a cloud chip 215, or monitoring-control layer in an external chip 300) may be configured for facilitating and/or performing optoelectronic performance monitoring. Alternatively or additionally, in various embodiments, the monitoring-control layer may be configured for facilitating and/or performing feedback control to modify optical parameters of one or more optical elements formed and/or disposed within the confinement apparatus system 200 (e.g., a photonic layer thereof). For example, a monitoring-control layer may be configured for facilitating and/or performing feedback control to modify amplitude, polarization, phase, alignment correction, optical power, and/or other optical parameters (for example, within the vacuum chamber). In this regard, the monitoring-control layer may be configured for facilitating and/or performing one or more functions associated with monitoring one or more optical parameters and/or providing feedback control to modify the one or more optical parameters (e.g., amplitude, polarization, phase, alignment, optical power, etc.).

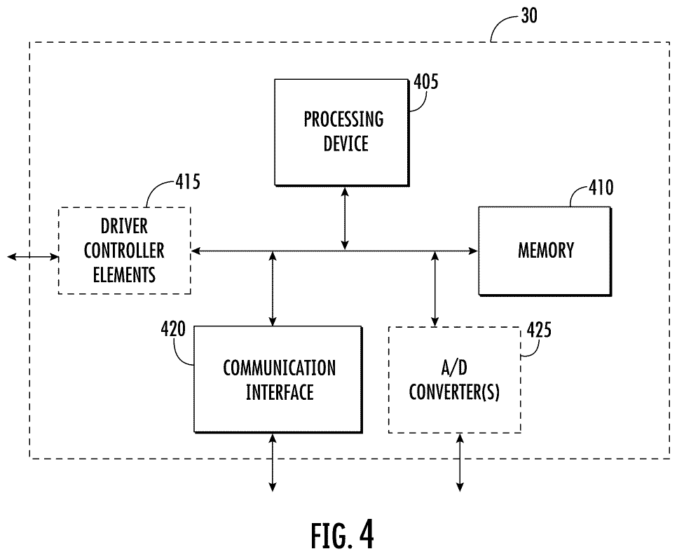

In various embodiments, one or more photodetectors, spatial filters, anti-reflective coatings, and/or other elements are formed and/or disposed on and/or in the monitoring-control layer. The photodetector(s) may be configured to detect one or more photons emitted by a quantum object located at a respective defined position of the confinement apparatus system 200. Alternatively or additionally, in various embodiments, a photodetector is configured to detect optical signals emitted from waveguides and/or gratings in a photonics layer. In various embodiments, the photodetectors may be photodiodes, photomultipliers, charge-coupled device (CCD) sensors, CMOS sensors, Micro-Electro-Mechanical Systems (MEMS) sensors, and/or other photodetectors that are sensitive to light necessary for quantum operations with or on the qubit. In various embodiments, the photodetectors are in electronic communication with the controller 30 via one or more analog-digital (A/D) converters 425 (see FIG. 4) and/or the like. For example, a quantum object being read and/or having its quantum state determined may emit an emitted signal, at least a portion of which is incident on a photodetector of the signal management system (e.g., formed and/or disposed on, near, and/or in a surface of the confinement apparatus chip 210). The emitted signal being incident on the photodetector may cause the photodetector to generate an electric signal that is passed to the controller 30.

In various embodiments, a monitoring-control layer (which may be embodied in the confinement apparatus chip 210, a bridge chip 205, a cloud chip 215, and/or an external chip 300) comprises a monitoring circuitry 301 and a feedback control circuitry 302. For example, in some embodiments, one or more of a confinement apparatus chip 210, a bridge chip 205, a cloud chip 215, and/or an external chip 300 comprises a monitoring circuitry 301 and a feedback control circuitry 302. In various embodiments, a monitoring-control layer (e.g., monitoring circuitry 301 and/or feedback control circuitry 302 thereof) is integrated with a photonic layer via a photodiode 311 such as an APD or single photon detector (SNSPD or the like). In various embodiments, the photodiode 311 is leveraged for integrating a monitoring-control layer with a photonic layer based on the photodiode 311 utilizing a process scheme that is aligned with silicon processes often used for ion-trap fabrication.

In various embodiments, the monitoring circuitry 301 is configured for performing one or more functions related to optoelectronic monitoring and control including, but not limited to, detection, conditioning, and multiplexing of optical signals on chip. For example, the monitoring circuitry 301 may be configured for photonic power, amplitude and/or phase monitoring and control utilizing photonic pick-off and signal integrity feedback. As another example, alternatively or additionally, the monitoring circuitry 301 may be configured for zone monitoring of ion fluorescence with downstream signal conditioning and multiplexing.

In various embodiments, the confinement apparatus system 200 comprise an ion trap comprising and/or associated with one or more detection zones 304, where each detection zone 304 includes at least one light source 312 (e.g., such as a manipulation source). In various embodiments, the monitoring circuitry 301 includes one or more detection circuitries 308 each associated with a particular detection zone 304 of the one or more detection zones 304. Each detection circuitry 308 (or at least one detection circuitry 308) may include a detector 305 (e.g., silicon-based detectors such as APDs, photo-modulated field effect transistors, SNSPDs, photocathodes, or the like) configured to receive an optical signal (e.g., generated by a light source). Such detector 305 may be configured to receive optical signal(s) from an optical element and/or a quantum object (e.g., qubit quantum object/ion). As shown in FIG. 3B, each detection circuitry 308 may further include a detector biasing component 315, an amplifier 310 (e.g., operational transconductance amplifier (OTA), or the like), and/or a quench and filter network 320 coupled to one or more other components of the respective detection circuitry 308. It would be appreciated that in some embodiments, the detector circuit may not include a quench and filter network 320 (or the quench component thereof). For example, in example embodiments, utilizing an SNSPD, the detector circuit may not include the quench and filter network 320 (or quench component thereof) while the quench and filter network 320 may be included in example embodiments utilizing APD(s) or photocathode(s).

The detector biasing component 315, amplifier 310, and/or quench and filter network 320 may be configured to facilitate operation of the respective detector and provide technical improvements. The quench component of the quench and filter network 320, for example, may be leveraged according to techniques described herein to suppress dark current. For example, photodiodes, such as APDs, may be operated in voltage or current modes that require dark current suppression. The filtration component of the quench and filter network 320 may be leveraged according to techniques described herein to allow the detection zones 304 to be fed into an integrated circuit such that the signals may be condensed into a single signal path for integration into a substrate (e.g., confinement apparatus chip 210, bridge chip 205, cloud chip 215, and/or external chip 300.). Moreover, the logical switching of detector bias and circuit connectivity capability of the configuration of the monitoring circuitry 301 allows for detection chain responses to be localized to when photon detection is expected and/or desired. Further, the detector biasing, via the detector biasing component(s) 315 eliminates undesired circuit response to stray light, which in turn reduces use-based failures and nonlinear detection response.

In various embodiments, the monitoring circuitry 301 further comprises a multiplexer array 325 positioned downstream the detector, 305, the detector biasing component 315, the amplifier 310, and the quench and filter network 320 for each zone. For example, the multiplexer array 325 may be coupled to the amplifier 310 and the quench and filter network 320 for each detection zone 304.

The monitoring circuitry 301, for example may embody a sensor-amplifier-multiplexer cascade comprising detector(s) 305, detector biasing component(s) 315, amplifier(s) 310, quench and filter network(s) 320, and a multiplexer array 325. In various embodiments, the multiplexer array 325 is configured for multiplexed electrical and readout of optical signals that are detected by the detector(s) 305. For example, the monitoring circuit may be configured to output signal (e.g., conditioned signals) corresponding to the optical signal received by the detector(s) via a corresponding light source or quantum object.

In various embodiments, the multiplexer array 325 and/or the sensor-amplifier-multiplexer cascade configuration of the monitoring circuitry 301 improves performance by addressing the complexity of a confinement apparatus (e.g., ion trap). For example, the scale and complexity of a confinement apparatus may require N signal monitoring points, such that a device with large M-fold photonic waveguide complexity would have even more vast N*M fold electrical power and signal routing difficulties. In this regard, the multiplexer array 325 and/or the sensor-amplifier-multiplexer cascade configuration of the monitoring circuitry 301 provides multiplexed electrical readout that addresses the noted complexity at least by providing signal reduction. Alternatively or additionally, the multiplexer array 325 and/or the sensor-amplifier-multiplexer cascade configuration of the monitoring circuitry 301 improves performance by allowing optical allocation to the multizone ion trap while simultaneously allowing signal circuitry with minimized output lines for in-situ (e.g., within the vacuum chamber) signal monitoring and conditioning. In various embodiments, the multiplexer array 325 may be coupled to a signal conditioning circuitry downstream (e.g., post photon acquisition). According to techniques described herein, detector responses may be converted from the detection signal stream via for example analog-to-digital circuitry, to logical signals (e.g., logical detection events). In various embodiments, the configuration of the monitoring circuitry 301 and/or the electronic components thereof, provide time localization of the detection events (e.g., time tagging/time binning capability and not merely a cumulative count during a fixed time interval. In such embodiments, the monitoring circuitry 301 may include or may be coupled to a logical circuitry to facilitate the time tagging/time binning capability such that improved time resolved photon detection is provided.

In various embodiments, and as illustrated in FIG. 3B, the feedback control circuitry 302 includes or is embodied as a proportional-integral-derivative (PID) controller 342. In various embodiments, the feedback control circuitry 302 is configured for providing optical power and/or signal feedback control. The feedback control circuitry 302, via the PID controller 342, may be configured to provide real-time system tuning to maintain system homeostasis by monitoring optical signals (e.g., feedback optical signal); analyzing the optical signals based on a predetermined standard (e.g., comparing the optical signals to a setpoint), or the like; and adjusting optical modulators and/or other tuning system(s) for light throughput based on the output of the analysis. For example, the PID controller 342 may be configured to calculate an error value by comparing the optical signals output by one or more optical elements to a setpoint and minimizing or eliminating the error by adjusting the optical signal output of the optical elements (e.g., via optical modulators and/or other tuning systems).

As shown in FIG. 3B, the PID controller 342 includes three control points, each embodied by a control coefficient. The three control points comprise a proportional control point 352, an integrate control point 354 (also referred to as integral control point), and a differentiate control point 356 (also referred to as derivative control point). The proportional control point 352 may correspond to or otherwise comprise the present error. The integrate control point 354 may correspond to or otherwise comprise the cumulative error over a time period. The differentiate control point 356 may correspond to or otherwise comprise the rate of change of error. The feedback control circuitry 302, via the control points, may be configured for controlling the optical signal in real-time.

As shown in FIG. 3B, the proportional control point 352, the integrate control point 354, and the differentiate control point 356 components are each coupled to a summation component 358. The summation component is coupled to an amplifier 360 and the signal output (e.g., control signal) of the amplifier 360 is coupled to an input of a subtraction component 362 (e.g., fed back to a subtraction component 362). As shown in FIG. 3B, a second input of the subtraction component 362 may comprise a setpoint 364. The subtraction component 362 may be configured to calculate the error by comparing the signal output to the setpoint 364 and automatically adjusting one or more optical modulators and/or other tuning systems to minimize or eliminate the error.

The depiction of the monitoring-control layer (and components thereof) in FIG. 3B is not intended to limit or otherwise confine the embodiments described and contemplated herein to any particular configuration or elements, nor is it intended to exclude any alternative configurations. For example, in some embodiments, the feedback control circuitry 302 may include or otherwise embodied as a FPGA-based feedback controller. For example, in some embodiments, the monitoring-control layer may include an integrated digital servo for feedback and control (e.g., for providing optical power and/or signal feedback control). The integrated digital servo may implement a DSP-based feedback transfer function to controller. In various embodiments, the integrated digital servo may include variable-gain amplifiers (VGA), analog-to-digital (ADC) converters, IIR and PID filtration components, lock-in oscillators, and digital-to-analog (DAC) conversion that are integrated monolithically integrated (e.g., via a silicon platform) or heterogeneously integrated within the confinement apparatus system 200. It would be appreciated that the monitoring-control layer may include other control modalities/configurations.

FIG. 3C illustrates an example optical encoding circuitry in accordance with at least some embodiments of the present disclosure, In some embodiments, alternatively or additionally, the confinement apparatus system 200 includes an optical encoding circuitry configured for monitoring electrical drive signals (e.g., high frequency electrical drive signals) such as radio RF signals or microwave (MW) signals, using electrodes (e.g., minimally intrusive electrodes) associated with optical modulators. In some embodiments, the optical encoding circuitry is formed and/or disposed on and/or in a monitoring-control layer such as monitoring-control layer 260, monitoring-control layer 262, monitoring-control layer 264, and/or a monitoring-control layer 266.

Parasitic effects can degrade the quality of low frequency (non-optical) RF and/or MW drive signals that are delivered to a confinement apparatus system, such as a confinement apparatus system 200. For example, electrical drive signals such as RF drive signals and/or MW drive signals may be delivered to one or more electrodes within the confinement apparatus system 200. In various embodiments, an optical encoding circuitry 303 comprising electro-optical, acoustic, and/or other modulation features is leveraged to encode the phase, frequency, and amplitude parameters/characteristics of the low frequency RF and/or low frequency MW drive signals into the optical domain.

As shown in FIG. 3C, the optical encoding circuitry 303 includes an optical modulator 386 (or other waveguide component) coupled to an electrical load 384 and an electrical drive 382 for generating RF signals and/or microwave signals. The optical modulator 386 is configured to encode signal characteristics (e.g., phase, amplitude, frequency, or other characteristics) of the of the drive signals (e.g., RF signals or MW signals) onto an optical carrier. In some examples, the optical carrier is a laser source. It would be appreciated that the optical carrier can be any suitable optical carrier. By encoding the signal characteristics, according to techniques described herein, provides for the drive signals to be impervious to external perturbation and as a source of crosstalk. The light from a light source 392 (e.g., manipulation source) is routed to detection electronics via waveguides 388, where the encoded characteristics (e.g., diagnostics data) can be accessed via a circuitry 390 (e.g., detection circuitry configured for heterodyne, spectrum analysis, or the like). For example, the optically encoded information can be routed to a detector to read (e.g., decode) the encoded characteristics. In some embodiments, highly stable infrared optical source passed through an electro-optic feature may pick up sidebands from the ion trap RF drive signal. For example, the encoded characteristics may be heterodyned with original high-stability infrared (IR) source to read the RF diagnostic data on heterodyne sidebands.

### Technical Advantages

Various embodiments provide technical solutions for monitoring and controlling optical performance of one or more optical elements of photonic integrated confinement apparatus. An implicit requirement for photonic integrated circuits (PIC) is the control infrastructure for system-level operation. Active integrated photonic components such as modulators, photodetectors, and solid-state sources like a laser diode must be networked with various electronic and optoelectronic circuitry for control of the photonic system. Even passive integrated photonic components require optical pick-offs for monitoring photonic beamline integrity and thereby utilizing optoelectronics for passive monitoring. Accordingly, a need exists for a fully-integrated photonic platform with the photonic components, optoelectronics, and control electronics monolithically co-integrated into a single chip.

Various embodiments of the present disclosure provide such integration and provide technical solutions to technical problems associated with integrating photonic components, optoelectronics, and control electronics monolithically into a single chip. In particular, various embodiments of the present disclosure include a photonic layer and a monitoring-layer formed and/or disposed on a substate such as silicon substrate. Various embodiments include silicon-based diode, such as an APD, that is leveraged to integrate the photonic layer and the monitoring-control layer. In various embodiments, the photonic layer includes one or more components configured for direct monitoring of one or more optical parameters. Further, in various embodiments, the photonic layer includes one or more components configured to re-direct optical signal to the monitoring-control layer for monitoring and/or control of optical performance.

Various embodiments of the present disclosure provide various technical advantages at least by providing such integration. In this regard, example embodiments of the present disclosure minimize the footprint of the optical beam delivery system. Example embodiments of the present disclosure minimize optical and electronic loss due to idealized system interfacing at the micro- or mesoscopic scale. Example embodiments of the present disclosure minimize latency between system output and control process. Example embodiments of the present disclosure minimize vibration given that the photonics and electronics are maximally registered to each other. Example embodiments of the present disclosure reduce noise injection due to cryogenic operation of both detector and supporting electronics. Further, example embodiments of the present disclosure provide for on-chip switching capability that can extend the ion trap package lifetime where degraded beamlines (e.g., waveguides and input facets) could be routed around without the need for full trap and beamline replacement.

### Exemplary Controller

In various embodiments, a confinement apparatus system 200 is incorporated into a system (e.g., a quantum computer 110) comprising a controller 30. In various embodiments, the controller 30 is configured to control various elements of the system (e.g., quantum computer 110). For example, the controller 30 may be configured to control the voltage sources 50, a cryogenic system and/or vacuum system controlling the temperature and pressure within the cryogenic and/or vacuum chamber 40, manipulation sources, cooling system, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the confinement apparatus system 200. In various embodiments, the controller 30 may be configured to receive signals from one or more photodetectors. According to various embodiments, the controller 30 may be associated with, include, or coupled to a monitoring circuitry 301 and/or feedback control circuitry 302.

As shown in FIG. 4, in various embodiments, the controller 30 may comprise various controller elements including processing elements 405 (e.g., processing device), memory 410, driver controller elements 415, a communication interface 420, analog-digital converter 425, and/or the like. For example, the processing elements 405 may comprise programmable logic devices (CPLDs), microprocessors, coprocessing entities, application-specific instruction-set processors (ASIPs), integrated circuits, (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 405 of the controller 30 comprises a clock and/or is in communication with a clock.

For example, the memory 410 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 410 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 410 (e.g., by a processing element 405) causes the controller 30 to perform one or more steps, operations, processes, procedures and/or the like described herein for providing manipulation signals to atomic object positions and/or collecting, detecting, capturing, and/or measuring indications of emitted signals emitted by quantum objects located at corresponding defined positions of the confinement apparatus system 200.

In various embodiments, the driver controller elements 415 may include one or more drivers and/or controller elements each configured to control one or more drivers. In various embodiments, the driver controller elements 415 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 405). In various embodiments, the driver controller elements 415 may enable the controller 30 to operate a voltage sources 50, manipulation sources, cooling system, and/or the like. In various embodiments, the drivers may be laser drivers configured to operate one or manipulation sources to generate manipulation signals; vacuum component drivers; drivers for controlling the flow of current and/or voltage applied to electrodes used for maintaining and/or controlling the trapping potential of the confinement apparatus system 200 (and/or other drivers for providing driver action sequences to potential generating elements of the confinement apparatus); cryogenic and/or vacuum system component drivers; cooling system drivers, and/or the like. In various embodiments, the controller 30 comprises means for communicating and/or receiving signals from one or more optical receiver components (e.g., photodetectors). For example, the controller 30 may comprise one or more analog-digital converter 425 configured to receive signals from one or more optical receiver components (e.g., a photodetector of the optics collection system), calibration sensors, and/or the like.

In various embodiments, the controller 30 may comprise a communication interface 420 for interfacing and/or communicating with a computing entity 10. For example, the controller 30 may comprise a communication interface 420 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Exemplary Computing Entity

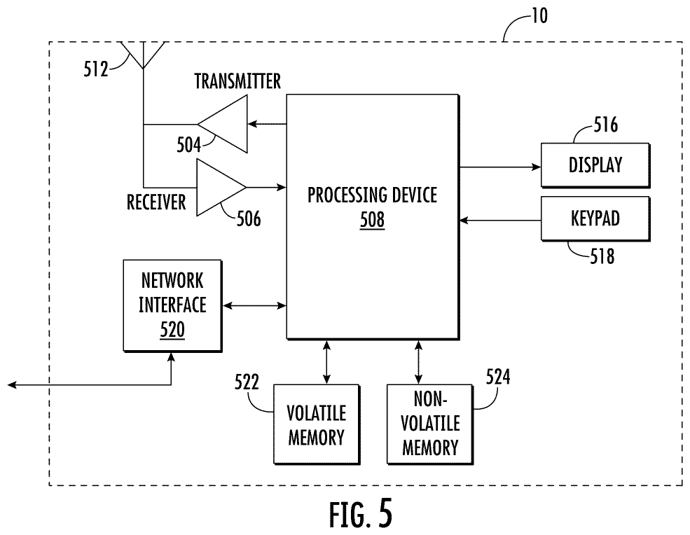

FIG. 5 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 5, a computing entity 10 can include an antenna 512, a transmitter 504 (e.g., radio), a receiver 506 (e.g., radio), and a processing element 508 (e.g., processing device) that provides signals to and receives signals from the transmitter 504 and receiver 506, respectively. The signals provided to and received from the transmitter 504 and the receiver 506, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 may comprise a network interface 520 for interfacing and/or communicating with the controller 30, for example. For example, the computing entity 10 may comprise a network interface 520 for providing executable instructions, command sets, and/or the like for receipt by the controller 30 and/or receiving output and/or the result of a processing the output provided by the quantum computer 110. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 516 and/or speaker/speaker driver coupled to a processing element 508 and a touch screen, keyboard, mouse, and/or microphone coupled to a processing element 508). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 518 (hard or soft), a touch display, voice/speech or motion interfaces, scanners, readers, or other input device. In embodiments including a keypad 518, the keypad 518 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 522 and/or non-volatile storage or memory 524, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A confinement apparatus system comprising:
a photonic layer comprising a plurality of optical elements, wherein at least one optical element of the plurality of optical elements is configured to output an optical signal; and
a monitoring-control layer comprising at least one of (i) monitoring circuitry or (ii) feedback control circuitry.

2. The confinement apparatus system of claim 1, further comprising an isolation layer formed on the monitoring-control layer, wherein the photonic layer is formed on the isolation layer.

3. The confinement apparatus system of claim 1, wherein the plurality of optical elements comprises one or more of (i) one or more opto-electronic sensors, (ii) one or more light sources, (iii) one or more passive photonic components, or (iv) one or more active photonic components.

4. The confinement apparatus system of claim 1, wherein the monitoring-control layer is configured for monitoring and controlling one or more optical parameters of the optical signal, wherein the one or more optical parameters include at least one of (i) amplitude, (ii) polarization, (iii) phase, (iv) alignment, or (v) optical power.

5. The confinement apparatus system of claim 1, wherein the monitoring circuitry comprises at least one of (i) one or more detection circuitries or (ii) a multiplexer array.

6. The confinement apparatus system of claim 5, wherein each detection circuitry of the one or more detection circuitries comprises a detector and one or more of a (i) biasing component, (ii) an amplifier, and (iii) a quench and filter network, wherein the detector is configured to receive an optical signal from one or more of (i) the at least one optical element or (ii) a qubit quantum object, and wherein the multiplexer array is configured to output a conditioned signal corresponding to the received optical signal.

7. The confinement apparatus system of claim 1, wherein the monitoring circuitry comprises a PID controller configured to monitor optical signals corresponding to output of the at least one optical element or a qubit quantum object; analyze the optical signals by comparing the optical signals to a setpoint; and adjust one or more optical modulators based on the analysis of the optical signals.

8. The confinement apparatus system of claim 1, further comprising one or more electrodes and an optical encoding circuitry configured for monitoring electrical drive signals delivered to the one or more electrodes.

9. The confinement apparatus system of claim 8, wherein the optical encoding circuitry comprises:
an optical modulator configured to encode one or more signal characteristics of the electrical drive signals onto an optical carrier; and
a detector configured to read the encoded one or more signal characteristics.

10. The confinement apparatus system of claim 8, wherein the monitoring-control layer further comprises the optical encoding circuitry.

11. The confinement apparatus system of claim 1, wherein the monitoring-control layer further comprises an integrated digital servo configured for providing optical signal feedback and control.

12. The confinement apparatus system of claim 1, wherein the plurality of optical elements of the photonic layer comprise one or more optical modulators, and the feedback control circuitry is configured to control the one or more optical modulators.

13. The confinement apparatus system of claim 12, wherein the one or more optical modulators comprise an acousto-optic modulator or an electro-optic modulator.

14. The confinement apparatus system of claim 1 further comprising a confinement apparatus chip, wherein at least one of the photonic layer or the monitoring-control layer is formed on the confinement apparatus chip.

15. The confinement apparatus system of claim 14, wherein the confinement apparatus chip comprises an optically transparent substrate.

16. The confinement apparatus system of claim 1, further comprising an ancillary chip, wherein at least one of the photonic layer or the monitoring-control layer is formed on the ancillary chip.

17. The confinement apparatus system of claim 16, wherein the ancillary chip comprises an optically transparent substrate.

18. The confinement apparatus system of claim 16, wherein the ancillary chip is one of a bridge chip, a cloud chip, or an external chip.

19. The confinement apparatus system of claim 1, further comprising a confinement apparatus chip and an ancillary chip, wherein the photonic layer is formed on the confinement apparatus chip and the monitoring-control layer is formed on the ancillary chip.

20. The confinement apparatus system of claim 1, further comprising a confinement apparatus chip and an ancillary chip, wherein the photonic layer is formed on the ancillary chip and the monitoring-control layer is formed on the confinement apparatus chip.
